(19) United States
(12) Patent Application Publication
(10) Pub. No.: US 2020/0065461 A1
(43) Pub. Date: Feb. 27, 2020

(54) TERMINAL DEVICE AND CONTROL PROGRAM

(71) Applicant: SHARP KABUSHIKI KAISHA, Sakai City, Osaka (JP)

(72) Inventor: TAKAHIRO MORI, Sakai City, Osaka (JP)

(21) Appl. No.: 16/467,446

(22) PCT Filed: Dec. 19, 2017
(86) PCT No.: PCT/JP2017/045565

§ 371 Date: Jun. 6, 2019

(30) Foreign Application Priority Data
Jan. 27, 2017 (JP) 2017-013611

(51) Int. Cl. G06F 21/32; G06F 21/84; H04M 1/66; G06K 9/00

(52) U.S. Cl. CPC G06F 21/32; G06K 9/00604; H04M 1/66; G06F 21/84

(57) ABSTRACT

According to the present invention, privacy of an operator of a terminal device is protected during and after authentication of the operator. The terminal device includes: a display section (39); a camera (20) configured so that an image capturing direction of the camera (20) is different from a direction outwardly extending from a surface on which the display section (39) is provided; an inclination sensor (22) configured to obtain an inclination of the terminal device (1); and a control section (10), the control section (10) being configured to: set a display-limited state in which display of the display section (39) is limited; carry out, in the display-limited state, authentication based on an image captured by the camera (20); and cancel the display-limited state in a case where (i) the authentication has been completed and it is determined that the inclination has changed by more than a prescribed value.

### TECHNICAL FIELD

The present invention relates to a terminal device and a control program.

### BACKGROUND ART

There has been proposed a method of authenticating a user based on an iris pattern or a venous pattern in the white of his/her eye captured in an image.

There has been also known a technique of unlocking a portable terminal device such as a mobile phone or smartphone, by authenticating an operator of the terminal device with use of an image of the eye captured by a camera mounted on the terminal device.

According to a technique disclosed in, for example, Patent Literature 1, an operator of a terminal device is authenticated based on the iris in a face captured in an image by a camera mounted on the terminal device. According to this technique; in a case where the iris of the image has at least a predetermined degree of similarity with a registered one, the terminal device is unlocked and opens a startup screen.

### CITATION LIST

### Patent Literature

[Patent Literature 1]

Japanese Patent Application Publication Tokukai No. 2006-093934 (Publication date: Apr. 6, 2006)

### SUMMARY OF INVENTION

### Technical Problem

Some terminal devices have no camera lens on a surface on which a display section is provided, but have a camera lens on another surface (such a camera is called a “back camera”). According to the knowledge found by the inventors of the present invention, such a terminal device exposes its display section to surroundings during authentication carried out by capturing an image of an operator of the terminal device with use of the back camera. This poses a risk of disturbing the user's privacy.

An object of an aspect of the present invention is to protect privacy of an operator of a terminal device during authentication of the operator which authentication is carried out on the terminal device.

### Solution to Problem

In order to solve the aforementioned problem, a terminal device in accordance with an aspect of the present invention includes: a display section; an image pickup section configured so that an image capturing direction of the image pickup section is different from a direction outwardly extending from a surface on which the display section is provided; an inclination obtaining section configured to obtain an inclination of the terminal device; and a control section, the control section being configured to: set a display-limited state in which display of the display section is limited; carry out, in the display-limited state, authentication based on an image captured by the image pickup section; and cancel the display-limited state in a case where (i) the authentication has been completed and (ii) it is determined that the inclination has changed by more than a prescribed value.

### Advantageous Effects of Invention

An aspect of the present invention brings about an effect of protecting privacy of an operator of a terminal device during authentication of the operator which authentication is carried out on the terminal device.

### BRIEF DESCRIPTION OF DRAWINGS

FIG. 1 is a block diagram schematically illustrating a configuration of a terminal device in accordance with Embodiment 1 of the present invention.

FIG. 2 is a view illustrating each angle detectable by an inclination sensor of the terminal device in accordance with Embodiment 1 of the present invention.

FIG. 3 is a functional block diagram illustrating the terminal device in accordance with. Embodiment 1 of the present invention.

FIG. 4 is a flowchart showing a process of controlling the terminal device in accordance with Embodiment 1 of the present invention.

FIG. 5 is a view schematically illustrating an operation of the terminal device in accordance with Embodiment 1 of the present invention.

FIG. 6 is a flowchart showing a process of controlling a terminal device in accordance with Embodiment 2 of the present invention.

### DESCRIPTION OF EMBODIMENTS

### Embodiment 1

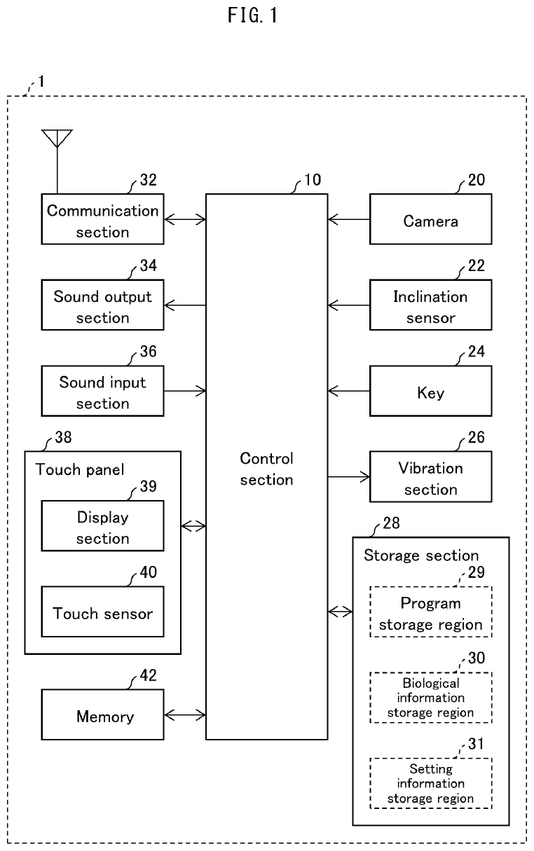

The following description will discuss an embodiment of the present invention with reference to FIGS. 1 through 5.

FIG. 1 is a block diagram schematically illustrating a configuration of a terminal device 1 in accordance with Embodiment 1 of the present invention.

The terminal device 1 may be a portable terminal device such as a mobile phone or a smartphone.

The terminal device 1 includes a control section 10, a camera (image pickup section) 20, an inclination sensor (inclination obtaining section) 22, a key 24, a vibration section 26, a storage section 28, a communication section 32, a sound output section 34, a sound input section 36, a touch panel (display section) 38, and a memory 42.

The touch panel 38 includes a display section 39 and a touch sensor 40.

The display section 39 is a display device such as a liquid crystal display.

The touch sensor 40 is configured to detect a position touched by an operator.

The camera 20 is configured to capture at least an image of an operator. The camera 20 is used to obtain an image of an operator for authentication but can also have a general camera function. In such a case, the camera may have an authentication-specific image capturing mode for use in authentication as well as a mode corresponding to the general camera function. The authentication-specific image capturing mode herein refers to a mode in which luminance, sharpness, and the like of an image are adjusted so that biometrics authentication can be carried out more precisely.

The camera 20 is a so-called back camera whose lens is provided on a surface other than a surface on which the display section 39 is provided. In Embodiment 1, the camera 20 is provided on a back surface opposite the surface on which the display section 39 is provided. Note that the terminal device 1 of Embodiment 1 includes the lens-equipped camera 20. Alternatively, the terminal device may include a lensless camera, provided that an image capturing direction is a direction outwardly extending from the back surface. The image capturing direction herein refers to a direction extending from the camera to a subject whose image is to be captured by the camera.

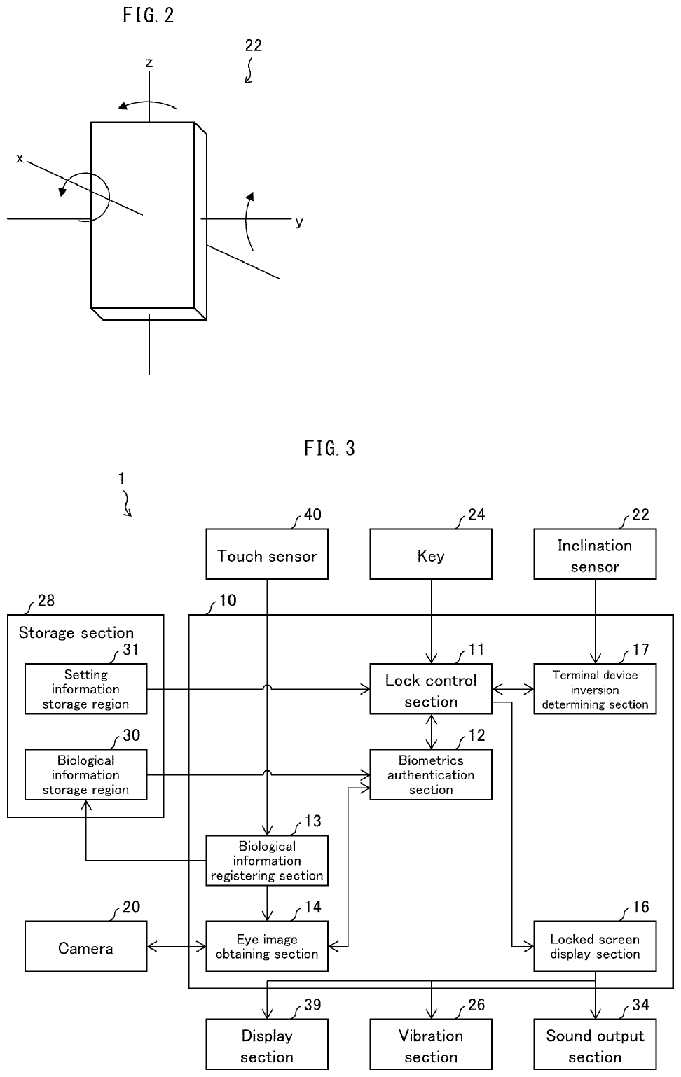

The inclination sensor 22 obtains an inclination of the terminal device 1. Specifically, the inclination sensor 22 obtains an inclination angle of each of three axes, an x axis, a y axis, and a z axis (see FIG. 2) of the terminal device 1. FIG. 2 illustrates a range of inclination angles of each axis, which can be obtained by the inclination sensor 22 while the terminal device 1 is oriented vertically to the ground. Of the three axes, the inclination angle of the z axis can vary within a range of 0 to 360 degrees.

The key 24 accepts an operator's input operation. The key 24 is a physical key such as a button.

The vibration section 26 vibrates the terminal device 1 in accordance with a pattern indicated by the control section 10.

The storage section 28 is a storage region in which data and program(s) are stored. The storage section 28 is configured by, for example, a flash memory. The storage section 28 includes a program storage region 29, a biological information storage region 30, and a setting information storage region 31.

In the biological information storage region 30, data for biometrics authentication of an operator is stored. The biometrics authentication of Embodiment 1 is carried out based on an image of the operator's eye. Thus, in the biological information storage region 30, data of a captured image of the operator's eye is stored as registration data. In the biological information storage region 30, it is possible to store, as the eye, instead of storing the entire image of the eye.

In the setting information storage region 31, setting information is stored, which setting information indicates how to authenticate an operator for unlocking the terminal device. In Embodiment 1, the setting information indicates eye image-based authentication.

The communication section 32 is connected to a mobile phone network and thereby performs voice communication and packet communication.

The sound output section 34 includes a speaker and a receiver. The sound output section 34 outputs sounds during voice communication via the mobile phone network or during playback of content.

The sound input section 36 includes a microphone. The sound input section 36 receives sounds during voice communication via the mobile phone network.

The memory 42 is a temporary memory for use in various types of control.

In order to carry out various types of control, the control section 10 operates a program stored in the program storage region 29. As illustrated in FIG. 3, the control section 10 includes functions of a lock control section 11, a biometrics authentication section 12, a biological information registering section 13, an eye image obtaining section 14, a locked screen display section 16, and a terminal device inversion determining section 17.

The lock control section 11 switches a screen of the display section 39 from an off state to an on state in response to the operator's input made via the key 24. Further, the lock control section 11 carries out control so as to cancel a display-limited state in accordance with the setting information read from the setting information storage region 31. In Embodiment 1, “display-limited state” refers to a state in which the lock control section 11 limits display of the display section 39. The display-limited state may encompass an off state of the display section 39. In a case where the setting information indicates eye image-based authentication for cancelling a display-limited state, the lock control section 11 requests the biometrics authentication section 12 to carry out an authentication process. Then, in a case where the lock control section 11 receives, from the biometrics authentication section 12, information indicating that authentication has succeeded, the lock control section 11 cancels, based on a determination result as described later, a display-limited state so as to control the display section 39 to display a standby screen.

The biometrics authentication section 12 authenticates an operator by making a comparison between (i) eye image data obtained from the eye image obtaining section 14 and (ii) registration data stored in the biological information storage region 30. In a case where the degree of similarity between the eye image data and the registration data is more than a prescribed value, the biometrics authentication section 12 determines that the authentication has succeeded. The biometrics authentication section 12 therefore sends this authentication result to the lock control section 11.

The biological information registering section 13 registers eye image data of an operator prior to execution of a biometrics authentication function. The biological information registering section 13 stores, as registration data, the eye image data in the biological information storage region 30.

The eye image obtaining section 14 starts up the camera so as to capture an image of an operator and then determines whether or not the captured image includes an eye image.

The locked screen display section 16 is controlled by the lock control section 11 to cause the display section 39 to display a certain screen. Examples of the certain screen include a locked screen, a screen that shows a result of biometrics authentication, and a screen for another authentication process such as an input screen that requests an operator to enter an unlock number. Further, by at least one of vibration(s) from the vibration section 26 and sound(s) from the sound output section 34, the locked screen display section 16 notifies an operator that authentication is completed.

Based on a change in inclination of the z axis which inclination was obtained from the inclination sensor 22, the terminal device inversion determining section 17 determines whether or not the terminal device 1 is inverted. In a case where the inclination has changed to a large extent, the terminal device inversion determining section 17 can determine that an operator has made such an operation as flipping the terminal device 1.

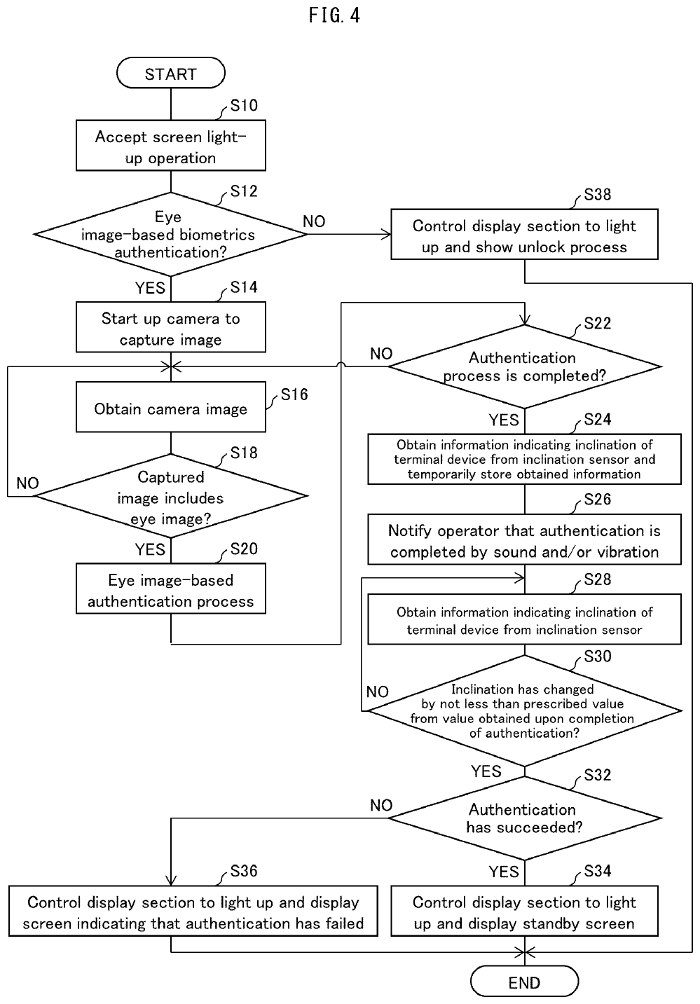

The following description will discuss a process of controlling the terminal device 1 of Embodiment 1 with reference to FIG. 4. FIG. 4 is a flowchart for illustrating the process of controlling the terminal device 1 of Embodiment 1.

In step S10, the lock control section 11 accepts an operator's operation of pressing down the key 24 and thereby starts control of display of the display section 39. When the lock control section 11 starts the control of the display of the display section 39, the display section 39 is in an off state. In this display-limited state, the lock control section 11 first obtains setting information from the setting information storage region 31.

In step S12, the lock control section 11 references the setting information and determines whether or not the setting information indicates eye image-based authentication. In a case where the lock control section 11 determines in step S12 that the setting information indicates the eye image-based biometrics authentication, the process proceeds to step S14. In a case where the lock control section 11 determines in step S12 that the setting information does not indicate the eye image-based biometrics authentication, the process proceeds to step S38.

In step S14, the lock control section 11 requests the biometrics authentication section 12 to carry out a biometrics authentication process. The biometrics authentication section 12 causes the eye image obtaining section 14 to start up the camera 20 so that the camera 20 starts capturing an image.

In step S16, the biometrics authentication section 12 causes the eye image obtaining section 14 to obtain the image captured by the camera 20.

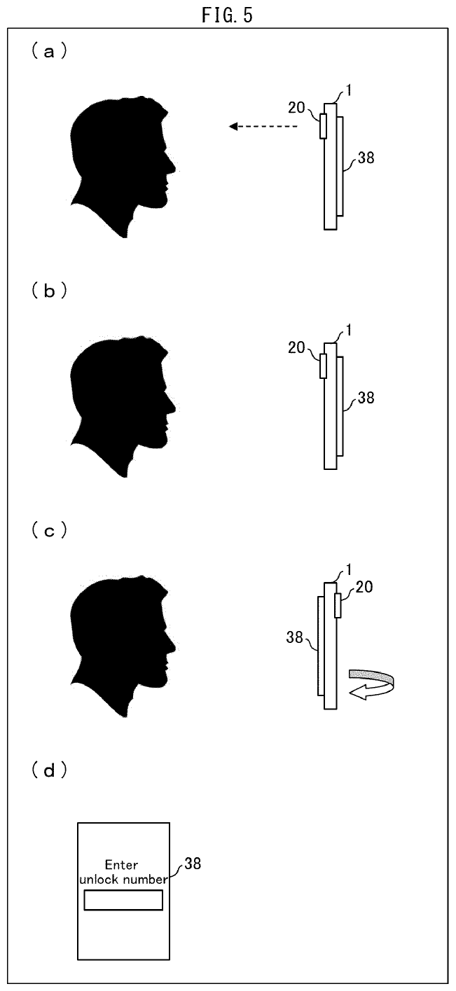

According to the terminal device 1 of Embodiment 1, a lens of the camera 20 is provided on a surface opposite a surface on which the touch panel 38 is provided (see (a) of FIG. 5). With this configuration, the touch panel 38 does not face an operator when the camera 20 captures his/her image. (a) of FIG. 5 shows that the camera 20 is capturing an image for authentication while the display section 39 is in an off state. The lens of the camera 20 and the touch panel 38 need only be provided on respective surfaces (e.g., the lens of the camera 20 can be provided on a surface which is a side surface with respect to the surface on which the touch panel 38 is provided). Alternatively, in a case where the terminal device includes a lensless camera, an image capturing direction of the camera need only be different from a direction outwardly extending from the surface on which the display section 39 is provided.

In step S18, the eye image obtaining section 14 determines whether or not the obtained image includes an eye image. In a case where the eye image obtaining section 14 determines in step S18 that the obtained image includes an eye image, the process proceeds to step S20. In a case where the eye image obtaining section 14 determines in step S18 that the obtained image includes no eye image, the process proceeds to step S16. Specifically, until the eye image obtaining section 14 determines that the obtained image includes an eye image, step S16 and step S18 are repeated.

In step S20, the biometrics authentication section 12 carries out an authentication process by making a comparison between (i) registration data obtained from the biological information storage region 30 and (the eye image data obtained from the eye image obtaining section 14.

In step S22, the biometrics authentication section 12 determines whether or not the authentication process has been completed. In a case where the biometrics authentication section 12 determines in step S22 that the authentication process has been completed, the process proceeds to step S24. In a case where the biometrics authentication section 12 determines in step S22 that the authentication process has not been completed, the process proceeds to step S16. Specifically, in a case where data corresponding to a single image of an eye is insufficient for the authentication process, the biometrics authentication section 12 obtains additional eye image data to continue the authentication process with use of the data.

In a case where the biometrics authentication section 12 determines that the authentication process has been completed, the lock control section 11 starts a process of determining whether or not the terminal device 1 is inverted.

First, in step S24, the lock control section 11 controls the terminal device inversion determining section 17 to obtain, from the inclination sensor 22, inclination information indicating an inclination of the terminal device 1. The terminal device inversion determining section 17 then temporarily stores the inclination information in the memory 42.

(b) of FIG. 5 shows that (i) the authentication process has been completed and (ii) the display section 39 is still in an off state.

In step S26, the lock control section 11 controls the locked screen display section 16 to notify, by at least one of vibration(s) from the vibration section 26 and sound(s) from the sound output section 34, the operator that the authentication is completed.

In step S28, the lock control section 11 controls the terminal device inversion determining section 17 to obtain, from the inclination sensor 22, the inclination information indicating the inclination of the terminal device 1.

In step S30, the terminal device inversion determining section 17 makes a comparison between (i) the inclination information that is temporarily stored in the memory 42 in step S24 and (ii) the inclination information obtained in step S28, and thereby determines whether or not the inclination of the terminal device 1 has changed by not less than a prescribed value. For example, in a case where (i) the prescribed value is 140 degrees, the inclination of the z axis obtained in step S24 is 20 degrees, and (iii) the inclination of the z axis obtained in step S28 is 160 degrees, the terminal device inversion determining section 17 determines that the terminal device 1 is inverted.

In a case where the terminal device inversion determining section 17 determines in step S30 that the inclination of the terminal device 1 has changed by not less than the prescribed value (i.e., the terminal device 1 is inverted), the process proceed to step S32. In a case where the terminal device inversion determining section 17 determines in step S30 that the inclination of the terminal device 1 has not changed by not less than the prescribed value, the process proceed to step S28. The terminal device inversion determining section 17 sends this determination result to the lock control section 11.

In step S32, the lock control section 11 determines whether or not the authentication process of the biometrics authentication section 12 has succeeded. In a case where the lock control section 11 determines in step S32 that the authentication process has succeeded, the process proceeds to step S34. In a case where the lock control section 11 determines in step S32 that the authentication process has failed, the process proceeds to step S36.

For example, in a case where the terminal device 1 is turned from a position, in which the lens of the camera 20 faces the operator (see (b) of FIG. 5), to a position in which the touch panel 38 faces the operator (see (c) of FIG. 5), the terminal device inversion determining section 17 determines that the inclination of the terminal device 1 has changed by not less than the prescribed value.

In step S34, the lock control section 11 controls the locked screen display section 16 so that the display section 39 lights up and displays a standby screen. With this, the series of steps in the flowchart of FIG. 4 ends.

In step S36, the lock control section 11 controls the locked screen display section 16 so that the display section 39 lights up and displays a screen indicating that the authentication has failed. With this, the series of steps in the flowchart of FIG. 4 ends. Alternatively, the lock control section 11 may control the locked screen display section 16 so that the display section 39 shows an unlock process. The unlock process may be, for example, one that requests an operator to enter an unlock number and compares the unlock number with a stored number so as to authenticate the operator (see (d) of FIG. 5).

In either case, when the touch panel 38 faces the operator (see (c) of FIG. 5), the lock control section 11 causes the display section 39 to light up; therefore, operator's convenience is not decreased.

In step S38, the lock control section 11 controls the locked screen display section 16 so that the display section 39 lights up and shows an unlock process. With this, the series of steps in the flowchart of FIG. 4 ends. Specifically, in a case where the lock control section 11 determines that the setting information does not indicate the eye image-based authentication, the lock control section 11 controls, in response to the key 24 being pressed down while the display section 39 is in an off state, the display section 39 to light up and show an unlock process.

The unlock process may be, as in step S36, one that requests the operator to enter an unlock number and compares the unlock number with a stored number, so as to authenticate the operator.

### Embodiment 2

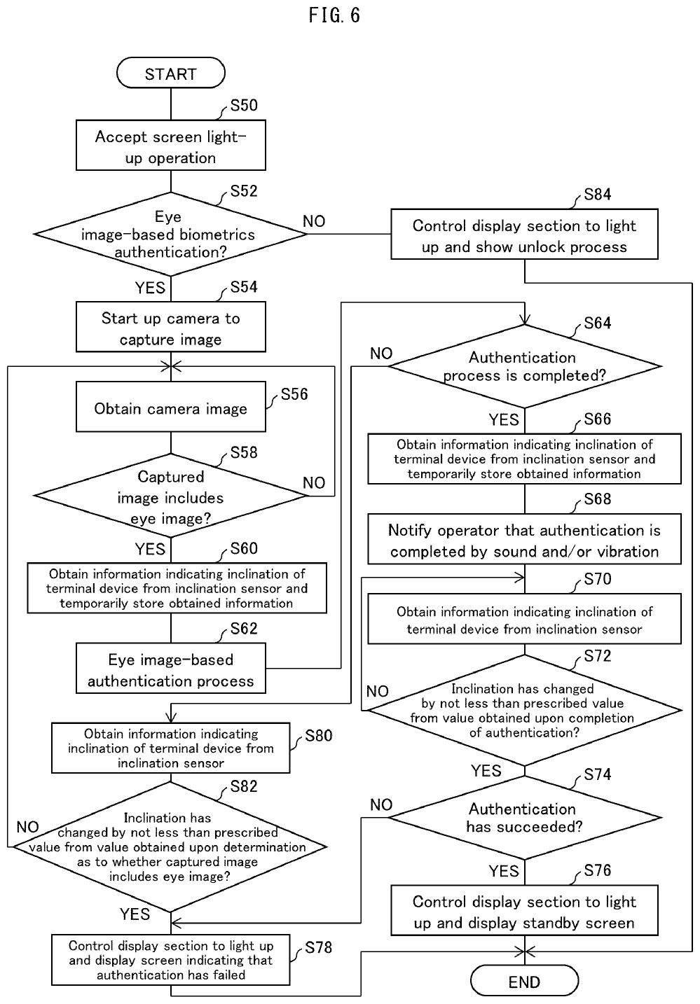

The following description will discuss another embodiment of the present invention with reference to FIG. 6. FIG. 6 is a flowchart illustrating a process of controlling a terminal device in accordance with Embodiment 2 of the present invention. Note that the terminal device of Embodiment includes members having functions identical to those described in Embodiment 1 and thus, identical reference signs will be given to these members and their descriptions will be omitted.

The process of controlling the terminal device of Embodiment 2 differs from that of Embodiment 1 in that steps S60, S80, and S82 are further included.

Steps S50 through S58, steps S62 through S78, and step S84 of Embodiment 2 correspond to steps S10 through S14, steps S16 through S36, and step S38 of Embodiment (illustrated in FIG. 4), respectively.

In Embodiment 2, in a case where it is determined in step S58 that an image captured by an eye image obtaining section 14 includes an eye image, a lock control section 11 controls the terminal device inversion determining section 17 to obtain, from an inclination sensor 22, inclination information indicating an inclination of a terminal device 1. Further, the terminal device inversion determining section 17 temporarily stores the inclination information in a memory 42 (step S60).

In Embodiment 2, in a case where it is determined that an authentication process of a biometrics authentication section 12 has not been completed, the process proceeds to a step (steps S80 and S82) of determining whether or not the terminal device 1 is inverted (step S64).

In step S80, a lock control section 11 controls the terminal device inversion determining section 17 to obtain, from an inclination sensor 22, the inclination information indicating the inclination of the terminal device 1.

In step S82, the terminal device inversion determining section 17 determines whether or not the inclination of the terminal device 1 has changed by not less than a prescribed value by making a comparison between (i) the inclination information that is temporarily stored in the memory 42 in step S60 and (ii) the inclination information obtained in step S80. In a case where the terminal device inversion determining section 17 determines in step S82 that the inclination of the terminal device 1 has changed by not less than the prescribed value, the process proceeds to step S78. In a case where the terminal device inversion determining section 17 determines in step S82 that the inclination of the terminal device 1 has not changed by not less than the prescribed value, the process proceeds to step S56.

Specifically, in a case where an operator wants to cancel an authentication process midway through the process, the configuration of Embodiment 2 allows the operator to cancel the authentication process by inverting the terminal device 1 instead of pressing down the key 24.

[Software Implementation Example]

Control blocks of the terminal device 1 (control section 10) can be realized by a logic circuit (hardware) provided in an integrated circuit (IC chip) or the like or can be alternatively realized by software as executed by a central processing unit (CPU).

In the latter case, the terminal device 1 includes a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be made available to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

[Recap]

A terminal device 1 in accordance with a first aspect of the present invention includes: a display section 39; an image pickup section (camera 20) configured so that an image capturing direction of the image pickup section is different from a direction outwardly extending from a surface on which the display section 39 is provided; an inclination obtaining section (inclination sensor 22) configured to obtain an inclination of the terminal device 1; and a control section 10, the control section 10 being configured to: set a display-limited state in which display of the display section 39 is limited; carry out, in the display-limited state, authentication based on an image captured by the image pickup section (camera 20); and cancel the display-limited state in a case where (i) the authentication has been completed and (ii) it is determined that the inclination has changed by more than a prescribed value.

With the configuration, the terminal device 1 can protect an operator's privacy during authentication of the operator, which authentication is carried out on the terminal device.

In a second aspect of the present invention, the terminal device 1 is configured such that in the first aspect: the image capturing direction is a direction outwardly extending from a back surface opposite the surface on which the display section 39 is provided; and the control section 10 cancels the display-limited state in a case where it is determined that the terminal device 1 is inverted.

With the configuration, the terminal device 1 can suitably protect an operator's privacy during authentication of the operator, which authentication is carried out on the terminal device.

In a third aspect of the present invention, the terminal device 1 is configured such that in the first or second aspect; in a case where it is determined, before the authentication is completed, that the inclination has changed by more than the prescribed value, the control section 10 cancels the display-limited state so as to control the display section 39 to display a screen that indicates that the authentication is cancelled.

With the configuration, in a case where an operator wants to cancel an authentication process midway through the process, the operator can cancel the authentication process by inverting the terminal device 1.

A terminal device in accordance with the aspects of the present invention may be realized by a computer. In such a case, the scope of the present invention encompasses: a control program for a terminal device, which causes a computer to operate as each section (software element) of the terminal device so that the terminal device can be realized by the stores the control program.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 Terminal device
10 Control section
20 Camera (image pickup section)
22 Inclination sensor (inclination obtaining section
39 Display section

1. A terminal device comprising:
a display section;
an image pickup section configured so that an image capturing direction of the image pickup section is different from a direction outwardly extending from a surface on which the display section is provided;
an inclination obtaining section configured to obtain an inclination of the terminal device; and
a control section,
the control section being configured to:
set a display-limited state in which display of the display section is limited;
carry out, in the display-limited state, authentication based on an image captured by the image pickup section; and
cancel the display-limited state in a case where (i) the authentication has been completed and (ii) it is determined that the inclination has changed by more than a prescribed value.

2. The terminal device as set forth in claim 1, wherein:
the image capturing direction is a direction outwardly extending from a back surface opposite the surface on which the display section is provided; and
the control section cancels the display-limited state in a case where it is determined that the terminal device is inverted.

3. The terminal device as set forth in claim 1, wherein in a case where it is determined, before the authentication is completed, that the inclination has changed by more than the prescribed value, the control section cancels the display-limited state so as to control the display section to display a screen that indicates that the authentication is cancelled.

4. A non-transitory computer-readable storage medium in which a control program for causing a computer to function as a control section of a terminal device is stored,
said terminal device comprising:
a display section;
an image pickup section configured so that an image capturing direction of the image pickup section is different from a direction outwardly extending from a surface on which the display section is provided; and
an inclination obtaining section configured to obtain an inclination of the terminal device,
said control section being configured to:
set a display-limited state in which display of the display section is limited;
carry out, in the display-limited state, authentication based on an image captured by the image pickup section; and
cancel the display-limited state in a case where (i) the authentication has been completed and (ii) it is determined that the inclination has changed by more than a prescribed value.
